(19) United States
(12) Patent Application Publication
(10) Pub. No.: US 2006/0170938 A1
(43) Pub. Date: Aug. 3, 2006

(54) Enhancing CMYK color workflow for CMYKF color

(75) Inventors: Victor Ignacio Ibarluzea, Brockport, NY (US); Chung-Hui Kuo, Fairport, NY (US); Hwai-Tzuu Tai, Rochester, NY (US)

Correspondence Address: Mark G. Bocchetti;Eastman Kodak Company, Patent Legal Staff, 343 State Street, Rochester, NY, 14650-2201, US

(73) Assignee: Eastman Kodak Company

(21) Appl. No.: 11/048,421

(22) Filed: Feb. 1, 2005

(51) Int. Cl. H04N 1/60

(52) U.S. Cl. 358/1.9

(57) ABSTRACT

A method of printing with a CMYKF or specialized CMYK printer comprising the steps of characterizing the CMYK gamut of the printer, characterizing the CMYKF or specialized CMYK gamut of the printer, morphing the L*a*b* data associated with the CMYK gamut into L*a*b*(*) data associated with the CMYKF gamut with pre-selected control points, constructing a L*a*b* to L*a*b*(*) transform function in accordance with the morphing step, and utilizing the L*a*b* to L*a*b*(*) transform function for printing with the printer.

### FIELD OF THE INVENTION

This invention is in the field of color printing, and is more specifically directed to managing the images in a color printing system that has more than a traditional four color CMYK printing press in order that a more vivid color area can be addressed.

### BACKGROUND OF THE INVENTION

Color printing systems seek to reproduce a broad range of colors present in natural scenes or synthetic (i.e. computer-generated) images using typically only three or four colorants (pigments, dyes, etc.) which are inherently less than ideal in their absorption characteristics. The necessity of working with non-ideal colorants not only limits the range of colors that may be reproduced, but requires careful compensation or color correction to be applied so that the printed colors are the best possible match to those of the original artwork. Efforts regarding such printing or printing systems have led to continuing developments to improve their versatility practicality, and efficiency.

### BRIEF DESCRIPTION OF THE DRAWINGS

FIG. 1 is a schematic diagram of an electrographic marking or reproduction system in accordance with the present invention.

FIG. 2 is a schematic diagram of an electrographic marking or reproduction system in accordance with the present invention.

FIG. 3 is an illustration of chromaticity diagram illustrating the difference between a CMYK color gamut and a CMYKF color gamut.

FIG. 4 is a flow chart of a transform function for a printer in accordance with the present invention.

FIG. 5 is a flow chart for operating a printer in accordance with the present invention.

FIG. 6 is an Illustration of an a*b* color projection plot of hue preserving morphing with set control points.

FIG. 7 is an Illustration of a 3-D plot of a*b* color with hue preserving morphing and set control points.

FIG. 8 is an Illustration of a 3-D plot of L*a* color with lightness preserving morphing.

### DETAILED DESCRIPTION

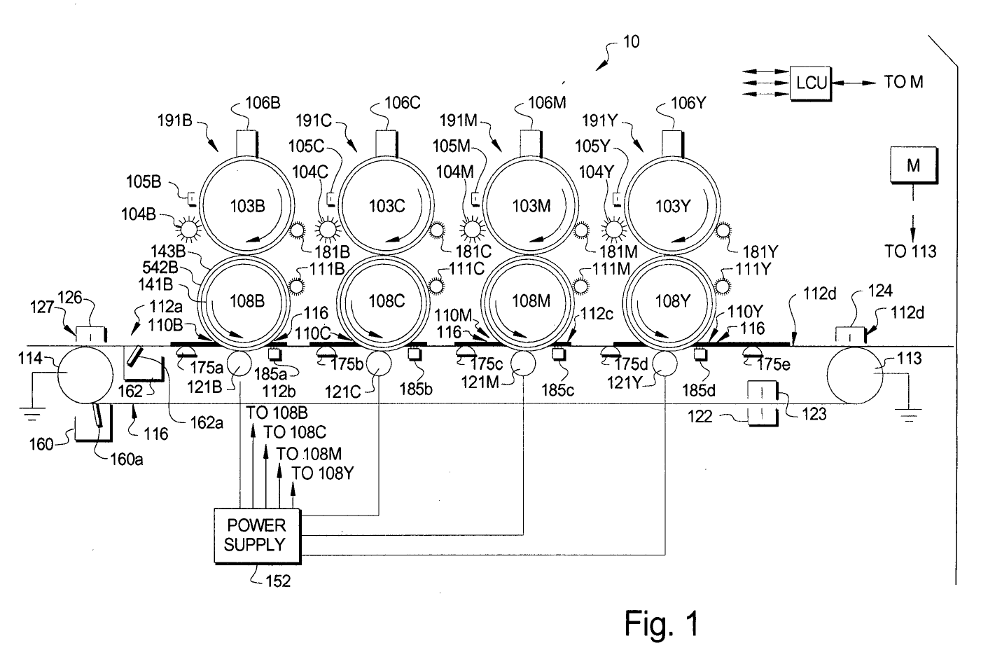

FIG. 1 illustrates an image forming reproduction apparatus or system according to an embodiment of the invention and designated generally by the numeral 10. The reproduction apparatus 10 is in the form of an electrophotographic reproduction apparatus and more particularly a color reproduction apparatus wherein color separation images are formed in each of four color modules (191B, 191C, 191M, 191Y) and transferred in register to a receiver member as a receiver member is moved through the apparatus while supported on a paper transport web (PTW) 116. More or less than four color modules may be utilized. For instance, the system may include a fifth color module or apparatus designated as F, thereby giving the print apparatus a CMYKF designation.

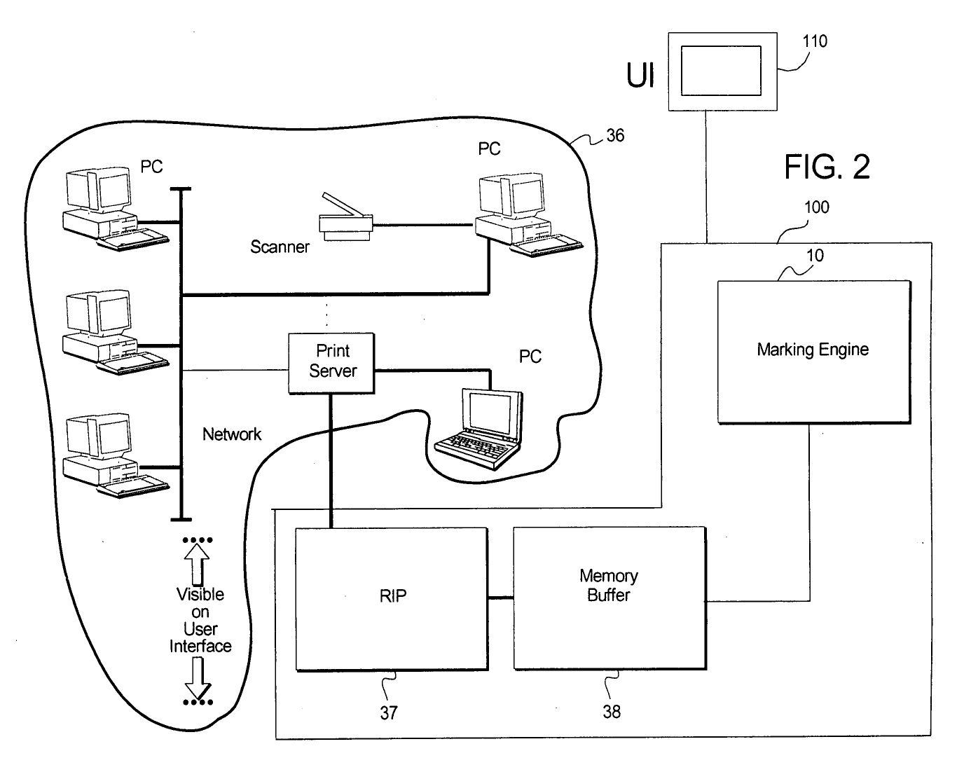

Each module is of similar construction except that as shown one paper transport web 116 which may be in the form of an endless belt operates with all the modules and the receiver member is transported by the PTW 116 from module to module. The elements in FIG. 2 that are similar from module to module have similar reference numerals with a suffix of B, C, M and Y referring to the color module to which it is associated; i.e., black, cyan, magenta and yellow, respectively. Four receiver members or sheets 112a, b, c and d are shown simultaneously receiving images from the different modules, it being understood as noted above that each receiver member may receive one color image from each module and that in this example up to four color images can be received by each receiver member. The movement of the receiver member with the PTW 116 is such that each color image transferred to the receiver member at the transfer nip of each module is a transfer that is registered with the previous color transfer so that a four-color image formed on the receiver member has the colors in registered superposed relationship on the receiver member. The receiver members are then serially detacked from the PTW and sent to a fusing station (not shown) to fuse or fix the dry toner images to the receiver member. The PTW is reconditioned for reuse by providing charge to both surfaces using, for example, opposed corona chargers 122, 123 which neutralize charge on the two surfaces of the PTW.

Each color module includes a primary image-forming member (PIFM), for example a rotating drum 103B, C, M and Y, respectively. The drums rotate in the directions shown by the arrows and about their respective axes. Each PIFM 103B, C, M and Y has a photoconductive surface, upon which a pigmented marking particle image, or a series of different color marking particle images, is formed. In order to form images, the outer surface of the PIFM is uniformly charged by a primary charger such as a corona charging device 105 B, C, M and Y, respectively or other suitable charger such as roller chargers, brush chargers, etc. The uniformly charged surface is exposed by suitable exposure means, such as for example a laser 106 B, C, M and Y, respectively or more preferably an LED or other electro-optical exposure device or even an optical exposure device to selectively alter the charge on the surface of the PIFM to create an electrostatic latent image corresponding to an image to be reproduced. The electrostatic image is developed by application of pigmented charged marking particles to the latent image bearing photoconductive drum by a development station 181 B, C, M and Y, respectively. The development station has a particular color of pigmented toner marking particles associated respectively therewith. Thus, each module creates a series of different color marking particle images on the respective photoconductive drum. In lieu of a photoconductive drum which is preferred, a photoconductive belt may be used.

Electrophotographic recording is described herein for exemplary purposes only. For example, there may be used electrographic recording of each primary color image using stylus recorders or other known recording methods for recording a toner image on a dielectric member that is to be transferred electrostatically as described herein. Broadly, the primary image is formed using electrostatography. In addition, the present invention applies to other printing systems as well, such as inkjet, thermal printing, etc.

Each marking particle image formed on a respective PIFM is transferred electrostatically to an outer surface of a respective secondary or intermediate image transfer member (ITM), for example, an intermediate transfer drum 108 B, C, M and Y, respectively. The PIFMs are each caused to rotate about their respective axes by frictional engagement with a respective ITM. The arrows in the ITMs indicate the directions of rotations. After transfer the toner image is cleaned from the surface of the photoconductive drum by a suitable cleaning device 104 B, C, M and Y, respectively to prepare the surface for reuse for forming subsequent toner images. The intermediate transfer drum or ITM preferably includes a metallic (such as aluminum) conductive core 141 B, C, M and Y, respectively and a compliant blanket layer 143 B, C, M and Y, respectively. The cores 141 C, M and Y and the blanket layers 143 C, M and Y are shown but not identified in FIG. 2. but correspond to similar structure shown and identified for module 191B. The compliant layer is formed of an elastomer such as polyurethane or other materials well noted in the published literature. The elastomer has been doped with sufficient conductive material (such as antistatic particles, ionic conducting materials, or electrically conducting dopants) to have a relatively low resistivity. With such a relatively conductive intermediate image transfer member drum, transfer of the single color marking particle images to the surface of the ITM can be accomplished with a relatively narrow nip width and a relatively modest potential of suitable polarity applied by a constant voltage potential source (not shown). Different levels of constant voltage can be provided to the different ITMs so that the constant voltage on one ITM differs from that of another ITM in the apparatus.

A single color marking particle image respectively formed on the surface 142B (others not identified) of each intermediate image transfer member drum, is transferred to a toner image receiving surface of a receiver member, which is fed into a nip between the intermediate image transfer member drum and a transfer backing roller (TBR) 121B, C, M and Y, respectively, that is suitably electrically biased by a constant current power supply 152 to induce the charged toner particle image to electrostatically transfer to a receiver sheet. Each TBR is provided with a respective constant current by power supply 152. The transfer backing roller or TBR preferably includes a metallic (such as aluminum) conductive core and a compliant blanket layer. Although a resistive blanket is preferred, the TBR may be a conductive roller made of aluminum or other metal. The receiver member is fed from a suitable receiver member supply (not shown) and is suitably “tacked” to the PTW 116 and moves serially into each of the nips 110B, C, M and Y where it receives the respective marking particle image in suitable registered relationship to form a composite multicolor image. As is well known, the colored pigments can overlie one another to form areas of colors different from that of the pigments. The receiver member exits the last nip and is transported by a suitable transport mechanism (not shown) to a fuser where the marking particle image is fixed to the receiver member by application of heat and/or pressure and, preferably both. A detack charger 124 may be provided to deposit a neutralizing charge on the receiver member to facilitate separation of the receiver member from the belt 116. The receiver member with the fixed marking particle image is then transported to a: remote location for operator retrieval. The respective ITMs are each cleaned by a respective cleaning device 111B, C, M and Y to prepare it for reuse. Although the ITM is preferred to be a drum, a belt may be used instead as an ITM.

Appropriate sensors such as mechanical, electrical, or optical sensors described hereinbefore are utilized in the reproduction apparatus 10′ to provide control signals for the apparatus. Such sensors are located along the receiver member travel path between the receiver member supply through the various nips to the fuser. Further sensors may be associated with the primary image forming member photoconductive drum, the intermediate image transfer member drum, the transfer backing member, and various image processing stations. As such, the sensors detect the location of a receiver member in its travel path, and the position of the primary image forming member photoconductive drum in relation to the image forming processing stations, and respectively produce appropriate signals indicative thereof. Such signals are fed as input information to a logic and control unit LCU including a microprocessor, for example. Based on such signals and a suitable program for the microprocessor, the control unit LCU produces signals to control the timing operation of the various electrostatographic process stations for carrying out the reproduction process and to control drive by motor M of the various drums and belts. The production of a program for a number of commercially available microprocessors, which are suitable for use with the invention, is a conventional skill well understood in the art. The particular details of any such program would, of course, depend on the architecture of the designated microprocessor.

The receiver members utilized with the reproduction apparatus 10 can vary substantially. For example, they can be thin or thick paper stock (coated or uncoated) or transparency stock. As the thickness and/or resistivity of the receiver member stock varies, the resulting change in impedance affects the electric field used in the nips 110B, C, M, Y to urge transfer of the marking particles to the receiver members. Moreover, a variation in relative humidity will vary the conductivity of a paper receiver member, which also affects the impedance and hence changes the transfer field. To overcome these problems, the paper transport belt preferably includes certain characteristics.

The endless belt or web (PTW) 116 is preferably comprised of a material having a bulk electrical resistivity. This bulk resistivity is the resistivity of at least one layer if the belt is a multilayer article. The web material may be of any of a variety of flexible materials such as a fluorinated copolymer (such as polyvinylidene fluoride), polycarbonate, polyurethane, polyethylene terephthalate, polyimides (such as Kapton™), polyethylene napthoate, or silicone rubber. Whichever material that is used, such web material may contain an additive, such as an anti-stat (e.g. metal salts) or small conductive particles (e.g. carbon), to impart the desired resistivity for the web. When materials with high resistivity are used additional corona charger(s) may be needed to discharge any residual charge remaining on the web once the receiver member has been removed. The belt may have an additional conducting layer beneath the resistive layer which is electrically biased to urge marking particle image transfer. Also acceptable is to have an arrangement without the conducting layer and instead apply the transfer bias through either one or more of the support rollers or with a corona charger. It is also envisioned that the invention applies to an electrostatographic color machine wherein a generally continuous paper web receiver is utilized and the need for a separate paper transport web is not required. Such continuous webs are usually supplied from a roll of paper that is supported to allow unwinding of the paper from the roll as the paper passes as a generally continuous sheet through the apparatus.

In feeding a receiver member onto belt 116, charge may be provided on the receiver member by charger 126 to electrostatically attract the receiver member and “tack” it to the belt 116. A blade 127 associated with the charger 126 may be provided to press the receiver member onto the belt and remove any air entrained between the receiver member and the belt.

A receiver member may be engaged at times in more than one image transfer nip and preferably is not in the fuser nip and an image transfer nip simultaneously. The path of the receiver member for serially receiving in transfer the various different color images is generally straight facilitating use with receiver members of different thicknesses.

The endless paper transport web (PTW) 116 is entrained about a plurality of support members. For example, as shown in FIG. 2, the plurality of support members are rollers 113, 114 with preferably roller 113 being driven as shown by motor M to drive the PTW (of course, other support members such as skis or bars would be suitable for use with this invention). Drive to the PTW can frictionally drive the ITMs to rotate the ITMs which in turn causes the PIFMs to be rotated, or additional drives may be provided. The process speed is determined by the velocity of the PTW.

Alternatively, direct transfer of each image may be made directly from respective photoconductive drums to the receiver sheet as the receiver sheet serially advances through the transfer stations while supported by the paper transport web without ITMs. The respective toned color separation images are transferred in registered relationship to a receiver member as the receiver member serially travels or advances from module to module receiving in transfer at each transfer nip a respective toner color separation image. Either way, different receiver sheets may be located in different nips simultaneously and at times one receiver sheet may be located in two adjacent nips simultaneously, it being appreciated that the timing of image creation and respective transfers to the receiver sheet is such that proper transfer of images are made so that respective images are transferred in register and as expected.

Other approaches to electrographic printing process control may be utilized, such as those described in international publication number WO 02/10860 a1, and international publication number WO 02/14957 A1, both commonly assigned herewith and incorporated herein by this reference.

Referring to FIG. 2, image data to be printed is provided by an image data source 36, which is a device that can provide digital data defining a version of the image. Such types of devices are numerous and include computer or microcontroller, computer workstation, scanner, digital camera, etc. Multiple devices may be interconnected on a network. These image data sources are at the front end and generally include an application program that is used to create or find an image to output. The application program sends the image to a device driver, which serves as an interface between the client and the marking device. The device driver then encodes the image in a format that serves to describe what image is to be generated on a page. For instance, a suitable format is page description language (“PDL”). The device driver sends the encoded image to the marking device. This data represents the location, color, and intensity of each pixel that is exposed. Signals from data source 36, in combination with control signals from LCU 24 are provided to a controller, which may include a raster image processor (RIP) 37 for rasterization. RIP 37, and a Memory Buffer 38. LCU 24, RIP 37, Memory Buffer 38 and Marking Engine 10 may all be provided in single mainframe 100, having a local user interface 110 (UI) for operating the system from close proximity.

In general, the major roles of the RIP 37 are to: receive job information from the server; parse the header from the print job and determine the printing and finishing requirements of the job; analyze the PDL (page description language) to reflect any job or page requirements that were not stated in the header; resolve any conflicts between the requirements of the job and the marking engine configuration (i.e., RIP time mismatch resolution); keep accounting record and error logs and provide this information to any subsystem, upon request; communicate image transfer requirements to the marking engine; translate the data from PDL (page description language) to raster for printing; and support diagnostics communication between user applications. The RIP accepts a print job in the form of a page description language (PDL) such as postscript, PDF or PCL and converts it into raster, or grid of lines or form that the marking engine can accept. The PDL file received at the RIP describes the layout of the document as it was created on the host computer used by the customer. This conversion process is also called rasterization as well as ripping. The RIP makes the decision on how to process the document based on what PDL the document is described in. It reaches this decision by looking at the beginning data of the document, or document header.

Raster image processing or ripping begins with a page description generated by the computer application used to produce the desired image. The raster image processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the halftone processer renders the byte map into a bit map for use by the printer. Halftone densities are formed by the application of a halftone “screen” to the byte map, especially in the case of image objects to be printed. Pre-press adjustments can include the selection of the particular halftone screens to be applied, for example to adjust the contrast of the resulting image.

Electrographic printers with gray scale printheads are also known, as described in international publication number WO 01/89194 a2, incorporated herein by this reference. The halftoning algorithm groups adjacent pixels into sets of adjacent cells, each cell corresponding to a halftone dot of the image to be printed. The gray tones are printed by increasing the level of exposure of each pixel in the cell, by increasing the duration by way of which a corresponding LED in the printhead is kept on, and by “growing” the exposure into adjacent pixels within the cell.

Once the document has been ripped by one of the interpreters, the raster data goes to a page buffer memory (PBM) 38 or cache via a data bus. The PBM eventually sends the ripped print job information to the marking engine 10. The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the rip. Once the images are in memory, they can be repeatedly read from memory and output to the print engine. The amount of memory required to store a given number of images can be reduced by compressing the images; therefore, the images may be compressed prior to memory storage, then decompressed while being read from memory.

The digital print system renders images both spatially and tonally and reproduces the image faithfully. A two dimensional image is represented by an array of discrete picture elements or pixels, and the color of each pixel is in turn represented by a plurality of discrete tone or shade values (usually an integer between 0 and 255) which correspond to the color components of the pixel: either a set of red, green and blue (RGB) values, a set of yellow, magenta, cyan, and black (CMYK) or a set of yellow, magenta, cyan, black and other (CMYKF or Hi-Fi color) values that will be used to control the amount of ink used by a printer to best approximate the measured color.

A color may be characterized by its lightness, saturation, and hue. One commonly used color measurement system is the calorimetric CIELAB or L*a*b* response, wherein the “L” represents the lightness of the color, the “a” represents the location of the color on a spectrum from red to green, and the “b” represents the location of the color on a spectrum from yellow to blue. The “a” and “b” taken together represent the saturation and hue of the color. The L*a*b* color measurement provides a simple means for calculating the “difference” or “similarity” of two different colors in absolute terms. While this absolute value does not reflect in what manner two colors differ, it does reflect how far apart they are in color appearance.

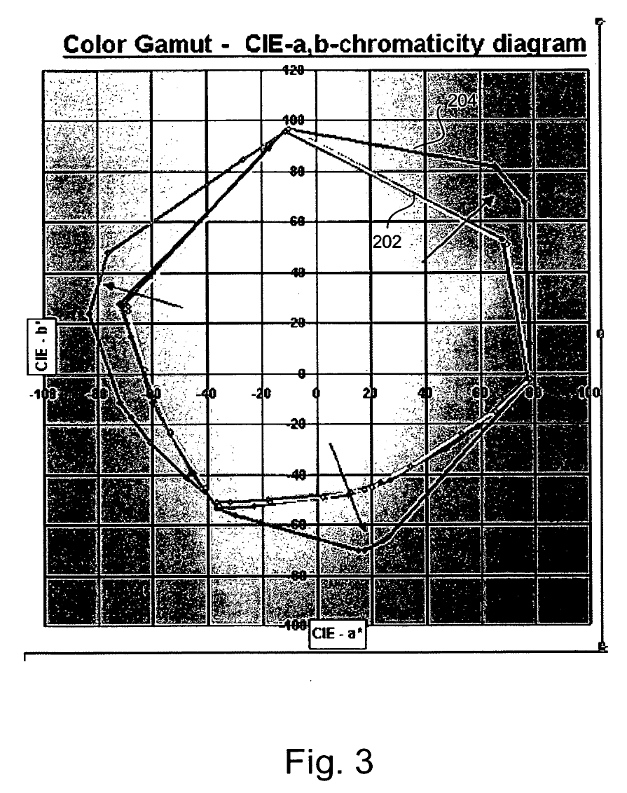

FIG. 3 illustrates a device color gamut which is the full range of colors that a device is able to produce. To specify the process of translation of an image to the color gamut of a destination device one uses the concept of rendering intent, which concept specifies the color gamut-matching strategy. Rendering intent concepts include: relative calorimetric matching, perceptual matching and saturation matching and absolute colorimetric matching. In relative colorimetric matching, in-gamut colors that are common to both devices (i.e., an input device and an output device are rendered color exactly with respect to the white point of the device), while colors that fall outside the gamut of the target device are adjusted (or mapped) to the next-closest equivalent. The white point is the printer media white that can be produced in a device's color gamut. Relative calorimetric rendering intent is suitable for precise color matching. In perceptual rendering intent, every color may be adjusted, while overall color relationships are preserved. This method is successful because the human perception is less objective to images that maintaining color relationships of the whole image than maintaining absolute colors while they are not fit well with respect to the surrounding colors in the image. In the case of saturation rendering intent the colors are pushed towards the gamut boundary such that the maximum saturation has been achieved. This type of color matching is suitable for graphics presentation. In the case of the absolute colorimetric rendering intent the native white point of the source image is preserved instead of adjusting to the output media as relative colorimetric intent does. The product of mapping from a device-independent color space (i.e. L*a*b*) to a device-dependent color representation of a printer or scanner is called a printer (or device) output transform. A printer output transform is constructed via inverse transformation of the printer input transform. While the printer input transform is constructed via the printer data that characterize the printer. To characterize a CMYK printer, a specific number of CMYK color patches (for example ISO 12640 IT8.7/3 target) are printed through the printer. The printed CMYK patches are measured (such as through a colorimeter or spectrophotometer) for their L*a*b* color responses. The pair relationships between CMYK value and L*a*b* response are established and the resultant data characterizes the printer. The L*a*b* volume associated with all the CMYK patches constitutes the printer gamut. This printer output transform may be a look-up table (LUT) that contains a large data set, or matrix, of color values representing the gamut of the target device (i.e., its range of reproducible colors) as applied to the reference color space (e.g., L*a*b*): for a particular ink/media combination. The LUT includes a data set that represents the reference color space and the matrix of color values representing the target device gamut is organized in relation to it.

A device that produces a color gamut may be a CMYK printer, such as that shown in FIG. 1. CMYK color printing devices have limited color gamut, or color space volume. Further some specialized CMYK color printing devices (such as super black colorant, or special hues of CMY colorants) have different sizes and shape color gamut than normal CMYK color printing device. The color gamut volume of CMYK printing device is usually smaller and a different shape than a RGB monitor device displaying an image to be printed by the CMYK printer. In a typical CMYK image workflow, the original image has been converted into CMYK color space based on well-characterized color standards such as SWOP or EURO color space for printing. This results in loss of color saturation & vivid color in the final image reproduction with CMYK printing. The workflow might include utilizing CMYK gamut data to print on a CMYKF gamut or specialized CMYK gamut printer. The workflow likewise might include utilizing CMYK gamut data of a CMYKF gamut or specialized CMYK gamut printer in order to print on the same or different CMYKF gamut or specialized CMYK gamut printer.

In a CMYKF (or Hi-Fi) color printing device, extra colorants such as red, green, blue, orange, or purple colors are used in the printing process. This enlarges the printer gamut and can produce more vivid color than CMYK printing devices. The CMYKF color gamut volume has extended color gamut in the direction of extra colorants color space but this extra colorant space will not be fully utilized in the original CMYK printing workflow unless additional steps are performed.

FIG. 3 illustrates a CMYK color gamut 202 and a CMYKF color gamut 204. It can be seen that the CMYK gamut is smaller and differently shaped than the CMYKF color gamut. The present invention provides a method for expanding the color gamut of a CMYK device to the color gamut of a CMYKF device. It is relevant to printing workflow. A workflow is the path that images follow as they move from one device to another. Various image quality may be resulted when printing workflows are not optimized. Due to a different workflow in accordance with the present invention, modifications of the image characteristics may be made to accommodate for the purpose of subjective improvements in the final appearance of the print.

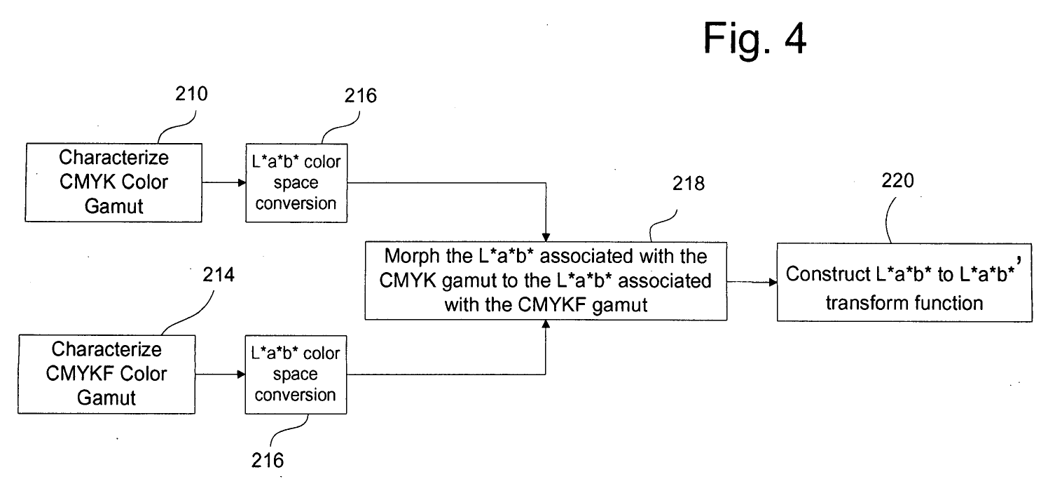

FIG. 4 illustrates a flow chart for constructing a color gamut transform function 232 wherein the CMYK color gamut of a printer is characterized in a step 210. The characterized printer data establishes the relationships between CMYK value and L*a*b* response. This CMYK to L*a*b* pair relationship can be modeled through local polynomial regression fitting or other mathematic functions as printer input transform. The printer input transform may be represented as 4D-LUT form. The CMYK color is converted to a L*a*b* color in a step 216 via input transform of the characterized printer. Similarly, the color of the Hi-Fi or CMYKF or specialized CMYK printer is characterized in a step 214 and a printer input transform for the Hi-Fi or CMYKF or specialized CMYK printer is constructed. The CMYKF color is converted to a L*a*b*(*) color utilizing the CMYKF characterized printer input transform of a step 216. The L*a*b* color for the CMYK printer has smaller volume than the L*a*b*(*) for the Hi-Fi or CMYKF or specialized CMYK printer as illustrated in FIG. 3. The L*a*b* color gamut of the CMYK printer is morphed into the L*a*b*(*) color gamut of CMYKF or specialized CMYK printer in a step 218 utilizing a morphing algorithm. The morphing algorithm deforms two L*a*b* color gamut elastically (analogous to a rubber band expansion) according to certain morphing criteria which is either hue or lightness preserving of L*a*b* color. A set of local color control points in L*a*b* of the CMYK color gamut are selected and their corresponding color control points in L*a*b* (*) of the CMYKF or specialized CMYK color gamut are identified according to the morphing criteria. These local control points guide L*a*b* and L*a*b* (*) color gamut morphing adaptively during elastic expansion. An example of morphing with these control points is to expand along the direction of the extra colorants color gamut area while remaining unchanged in other similar color gamut area. The local control points are pre-selected or predetermined according to their different color gamut shape or selected as user preferences for the vivid color control of the images to be rendered in the perceptual rendering intent. The control points may be selected so that hue-preserving and lightness preserving in the L*a*b* to L*a*b*(*) mapping provides that a larger color gamut is achieved when printing. In a step 220, a L*a*b* to L*a*b*(*) transform function for the printer is then constructed in accordance with the results of the morphing step 218. An example of implementation of a transform function is a lookup table (LUT).

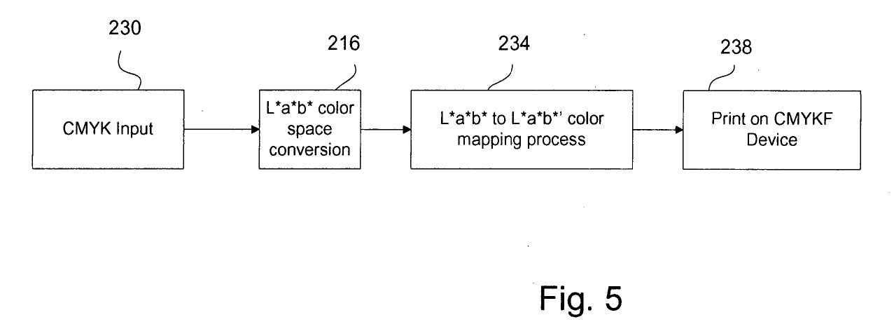

FIG. 5 illustrates a flow chart of a printing process in a CMYK workflow in accordance with the present invention, wherein a printer or print system is provided CMYK color data input in a step 230. The CMYK color space data representing an image is converted to the L*a*b* color space data associated therewith utilizing a conversion algorithm in a step 216. This CMYK to L*a*b* conversion may be based on SWOP or EURO color standard or other target printing device color space. In a step 234, the L*a*b* color space data is then mapped into L*a*b*(*) color space data utilizing the transform algorithm constructed in step 220 of FIG. 4. The printer then prints out the image utilizing the L*a*b*(*) color space data in a step 238.

The present invention is therefore a method of printing comprising the steps of accepting an image created in a CMYK gamut, utilizing a transform function to expand the gamut of the image into a CMYKF or specialized CMYK gamut; and then printing the image. The transform function may be derived by characterizing the CMYK gamut of the printer, characterizing the CMYKF or specialized CMYK gamut of the printer and morphing the L*a*b* data associated with the CMYK gamut into L*a*b*(*) data associated with the CMYKF gamut with pre-selected control points. A controller such as that in FIG. 2 may perform these functions.

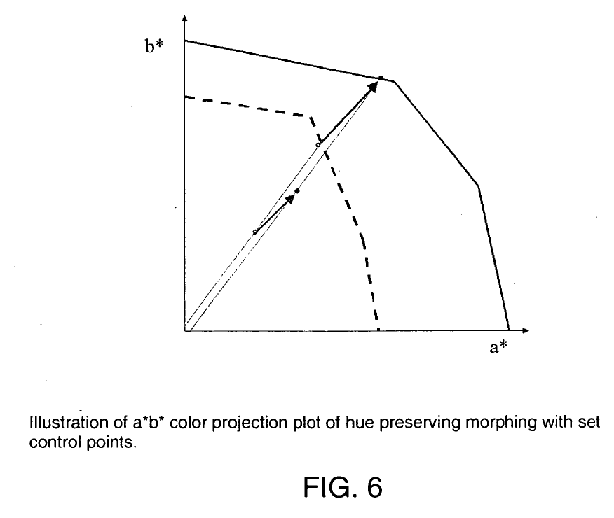

FIG. 6 is an illustration of CMYK to CMYKF morphing in a*b* color projection plot. The illustrated control points are located on the boundary of a two color gamut surface. The morphing algorithm utilizes these control points to create smooth transformation from one color gamut to another gamut while preserving hue.

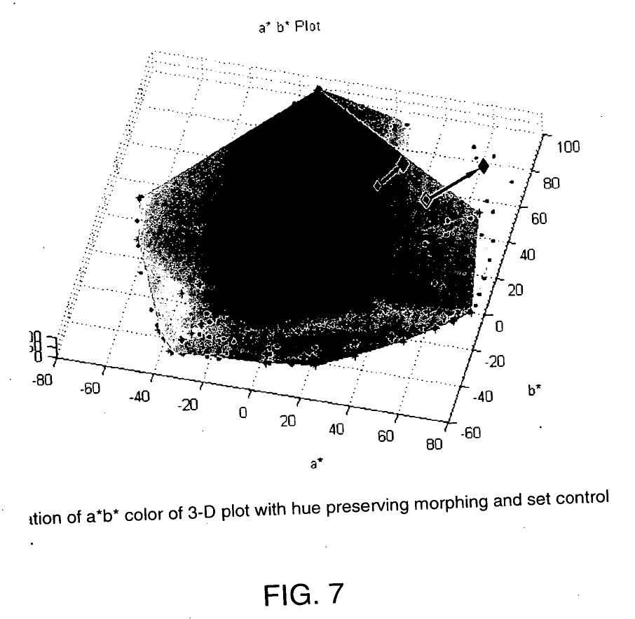

FIG. 7 is a 3-D illustration of CMYK to CMYKF morphing of different a*b* projections that is hue preserving morphing. The selected points are the control points for the corresponding color gamut.

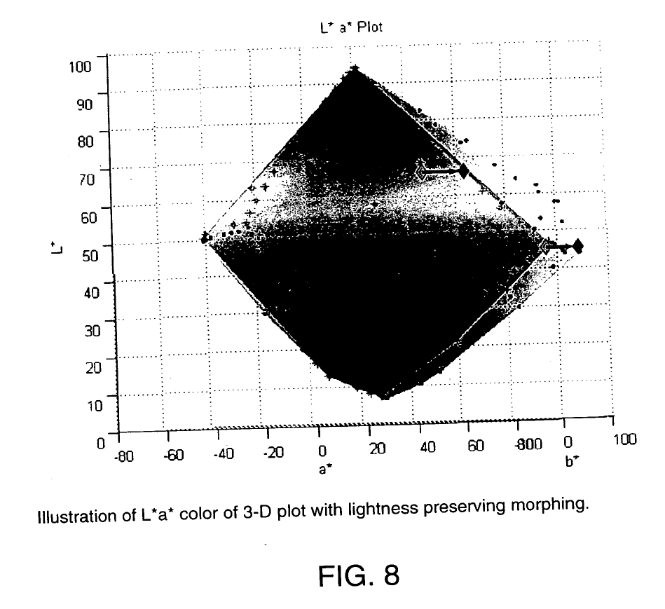

FIG. 8 is a 3-D illustration of CMYK to CMYKF morphing of different L*a* color with lightness preserving morphing. The selected points are the control points for the corresponding color gamut.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

1. A method of printing with a CMYKF or specialized CMYK printer comprising the steps of:
characterizing the CMYKF or specialized CMYK gamut of the printer;
characterizing the CMYK gamut of the printer;
morphing the L*a*b* data associated with the CMYK gamut into L*a*b*(*) data associated with the CMYKF gamut with pre-selected control points;
constructing a L*a*b* to L*a*b*(*) transform function in accordance with the morphing step; and,
utilizing the L*a*b* to L*a*b*(*) transform function for printing with the printer.

2. The method in accordance with claim 1, wherein the utilizing step is performed during rasterization of the image.

3. A method of printing with a CMYKF or specialized CMYK printer comprising the steps of:
utilizing a L*a*b* to L*a*b*(*) transform function to print with the printer, wherein the L*a*b* to L*a*b*(*) transform function was derived by:
characterizing the CMYK gamut of the printer;
characterizing the CMYKF or specialized CMYK gamut of the printer; and
morphing the L*a*b* data associated with the CMYK gamut into L*a*b*(*) data associated with the CMYKF gamut with pre-selected control points.

4. The method in accordance with claim 3, wherein the utilizing step is performed during rasterization of the image.

5. A CMYKF or specialized CMYK printer for printing an image comprising:
a controller for:
utilizing a L*a*b* to L*a*b*(*) transform function to print with the printer, wherein the L*a*b* to L*a*b*(*) transform function was derived by:
characterizing the CMYK gamut of the printer;
characterizing the CMYKF or specialized CMYK gamut of the printer; and
morphing the L*a*b* data associated with the CMYK gamut into L*a*b*(*) data associated with the CMYKF or specialized CMYK gamut with pre-selected control points set.

6. A printer in accordance with claim 5, wherein the L*a*b* to L*a*b*(*) transform function is utilized during rasterization of the image.

7. A method of printing comprising the steps of:
accepting an image created in a CMYK gamut;
utilizing a transform function to expand the gamut of the image into a CMYKF or specialized CMYK gamut; and, printing the image.

8. A method of printing in accordance with claim 7, wherein transform function is derived by:
characterizing the CMYK gamut of the printer;
characterizing the CMYKF or specialized CMYK gamut of the printer; and
morphing the L*a*b* data associated with the CMYK gamut into L*a*b*(*) data associated with the CMYKF gamut with pre-selected control points.

9. A printer comprising:
a controller for accepting an image created in a CMYK gamut; utilizing a transform function to expand the gamut of the image into a CMYKF or specialized CMYK gamut; and controlling the printing of the image.

10. A printer in accordance with claim 9, wherein transform function is derived by:
characterizing the CMYK gamut of the printer;
characterizing the CMYKF or specialized CMYK gamut of the printer; and
morphing the L*a*b* data associated with the CMYK gamut into L*a*b*(*) data associated with the CMYKF gamut with pre-selected control points.
